(19) United States
(12) Patent Application Publication
(10) Pub. No.: US 2008/0096536 A1
(43) Pub. Date: Apr. 24, 2008

(54) Mobile terminal apparatus, method of controlling transmission and reception of request, and computer product

(75) Inventors: Hidenori Tonosaki, Kawasaki (JP); Chisara Yamazaki, Kawasaki (JP); Tatsuya Hiraishi, Kawasaki (JP); Yoshiyuki Imai, Kawasaki (JP); Tatsuo Yagi, Kawasaki (JP); Takeyasu Tomioka, Kawasaki (JP); Makoto Funaoka, Kawasaki (JP); Toshifumi Aso, Kawasaki (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: FUJITSU LIMITED, Kawasaki (JP)

(21) Appl. No.: 11/790,955

(22) Filed: Apr. 30, 2007

(30) Foreign Application Priority Data
Oct. 23, 2006 (JP) 2006-287920

(51) Int. Cl. H04M 3/42; H04M 1/00

(52) U.S. Cl. 455/415; 455/550.1

(57) ABSTRACT

Upon receiving a selection of a name of a member of a desired reception destination by an input through a button operation, the caller's mobile terminal apparatus transmits a hiding-number outgoing-call request including a caller's phone number and a phone-number hiding flag to a receiver's phone number. The receiver's mobile terminal apparatus acquires, when the phone-number hiding flag is included in the received hiding-number outgoing-call request, a name corresponding to the caller's phone number, displays an incoming-call screen with acquired name on a display unit.

### BACKGROUND OF THE INVENTION

1. Field of the Invention

The present invention relates to a technology for controlling transmission and reception of an outgoing-call request and an incoming-call request via a network.

2. Description of the Related Art

These days, instead of dialing a telephone number, it has become possible to make a telephone call by selecting a phone number registered in advance in a telephone terminal. For instance, Japanese Patent Application Laid-Open No. H9-233187 discloses a technology in which when a calling person keys in a name of a receiving person in his telephone terminal, a phone number corresponding to the receiving person is retrieved from information stored in advance in the telephone terminal of the calling person, and a call is established between the telephone terminals of the calling person and the receiving person.

However, the conventional technology described above has a problem in that personal information is not protected, because the phone number of the calling person is explicitly disclosed to the receiving person.

Thus, there is a need of a technology that makes it possible to protect personal information by not disclosing the information about the calling person to the receiving person.

### SUMMARY OF THE INVENTION

It is an object of the present invention to at least partially solve the problems in the conventional technology.

According to an aspect of the present invention, a mobile terminal apparatus that performs transmission of an outgoing-call request to and reception of an incoming-call request from other mobile terminal apparatus via a network, includes a phone-number-information storing unit that stores therein name information of a user of the other mobile terminal apparatus in association with phone-number information unique to the other mobile terminal apparatus; a receiver-phone-number acquiring unit that acquires, when a name of the user of the other mobile terminal apparatus is received from a user of the mobile terminal apparatus, a receiver phone number corresponding to received name from the phone-number information stored in the phone-number-information storing unit; an outgoing-call-request transmitting unit that transmits an outgoing-call request including a caller phone number of the mobile terminal apparatus and a phone-number hiding flag for hiding the caller phone number to acquired receiver phone number via the network; an incoming-call-request receiving unit that receives an outgoing-call request transmitted from the other mobile terminal apparatus via the network as an incoming-call request; a phone-number-hiding-flag confirming unit that confirms whether a phone-number hiding flag is included in received incoming-call request; a name-information acquiring unit that acquires, when it is confirmed that the phone-number hiding flag is included in the received incoming-call request, a name corresponding to a caller phone number of the other mobile terminal apparatus from the name information stored in the phone-number-information storing unit; and a display control unit that controls a display unit to display thereon acquired name.

According to another aspect of the present invention, a method of controlling transmission and reception of request between a mobile terminal apparatus and other mobile terminal apparatus via a network, includes storing name information of a user of the other mobile terminal apparatus in association with phone-number information unique to the other mobile terminal apparatus in a phone-number-information storing unit; acquiring, when a name of the user of the other mobile terminal apparatus is received from a user of the mobile terminal apparatus, a receiver phone number corresponding to received name from the phone-number information stored in the phone-number-information storing unit; transmitting an outgoing-call request including a caller phone number of the mobile terminal apparatus and a phone-number hiding flag for hiding the caller phone number to acquired receiver phone number via the network; receiving an outgoing-call request transmitted from the other mobile terminal apparatus via the network as an incoming-call request; confirming whether a phone-number hiding flag is included in received incoming-call request; acquiring, when it is confirmed that the phone-number hiding flag is included in the received incoming-call request, a name corresponding to a caller phone number of the other mobile terminal apparatus from the name information stored in the phone-number-information storing unit; and controlling a display unit to display thereon acquired name.

According to still another aspect of the present invention, an apparatus for controlling transmission of an outgoing-call request from a transmission-source mobile terminal apparatus and reception of the outgoing-call request by a reception-destination mobile terminal apparatus from among a plurality of mobile terminal apparatuses, includes a phone-number-information storing unit that stores therein name information of users of the mobile terminal apparatuses in association with phone-number information of the mobile terminal apparatuses; a name-information acquiring unit that acquires, when an outgoing-call request including a caller phone number and a phone-number hiding flag for hiding the caller phone number to the reception-destination mobile terminal apparatus is received from the transmission-source mobile terminal apparatus, a name corresponding to the caller phone number from the name information stored in the phone-number-information storing unit; and a display control unit that controls, when transferring the outgoing-call request to the reception-destination mobile terminal apparatus, a display unit of the reception-destination mobile terminal apparatus to display thereon acquired name.

According to still another aspect of the present invention computer-readable recording medium stores therein a computer program that implements the above method on a computer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining an outline and characteristics of a mobile terminal apparatus according to a first embodiment of the present invention;

FIG. 2 is a schematic diagram for explaining an example of data configuration of a hiding-number outgoing-call request according to the first embodiment;

FIG. 3 is a schematic diagram for explaining parameters of hiding information according to the first embodiment;

FIG. 4 is a detailed functional block diagram of the mobile terminal apparatus according to the first embodiment;

FIG. 5 is an example of contents of a phone-number hiding information table shown in FIG. 4;

FIG. 6 depicts examples of an incoming-call screen according to the first embodiment;

FIG. 7 is a flowchart of a process of transmitting a hiding-number outgoing-call request according to the first embodiment;

FIG. 8 is a flowchart of a process of handling a hiding-number incoming-call request according to the first embodiment;

FIG. 9 is an example of contents of a phone-number hiding information table according to a second embodiment of the present invention;

FIG. 10 depicts an example of a screen displayed in the second embodiment;

FIG. 11 is a flowchart of a process of transmitting a hiding-number outgoing-call request according to the second embodiment;

FIG. 12 is a flowchart of a process of handling a hiding-number incoming-call request according to the second embodiment;

FIG. 13 is a schematic diagram for explaining an outline and characteristics of a mobile terminal apparatus according to a third embodiment of the present invention;

FIG. 14 is a detailed functional block diagram of the mobile terminal apparatus according to the third embodiment;

FIG. 15 is a flowchart of a process of updating a phone-number hiding information table shown in FIG. 14;

FIG. 16 is a flowchart of a process of automatically deleting table data from phone-number hiding information table according to a fourth embodiment of the present invention;

FIG. 17 is a functional block diagram of a computer that implements the first and the second embodiments as software; and

FIG. 18 is a functional block diagram of a computer that implements the third and the fourth embodiments as software.

### DETAILED DESCRIPTION OF THE PREFERRED EMBODIMENTS

Exemplary embodiments according to the present invention will be explained in detail below with reference to the accompanying drawings.

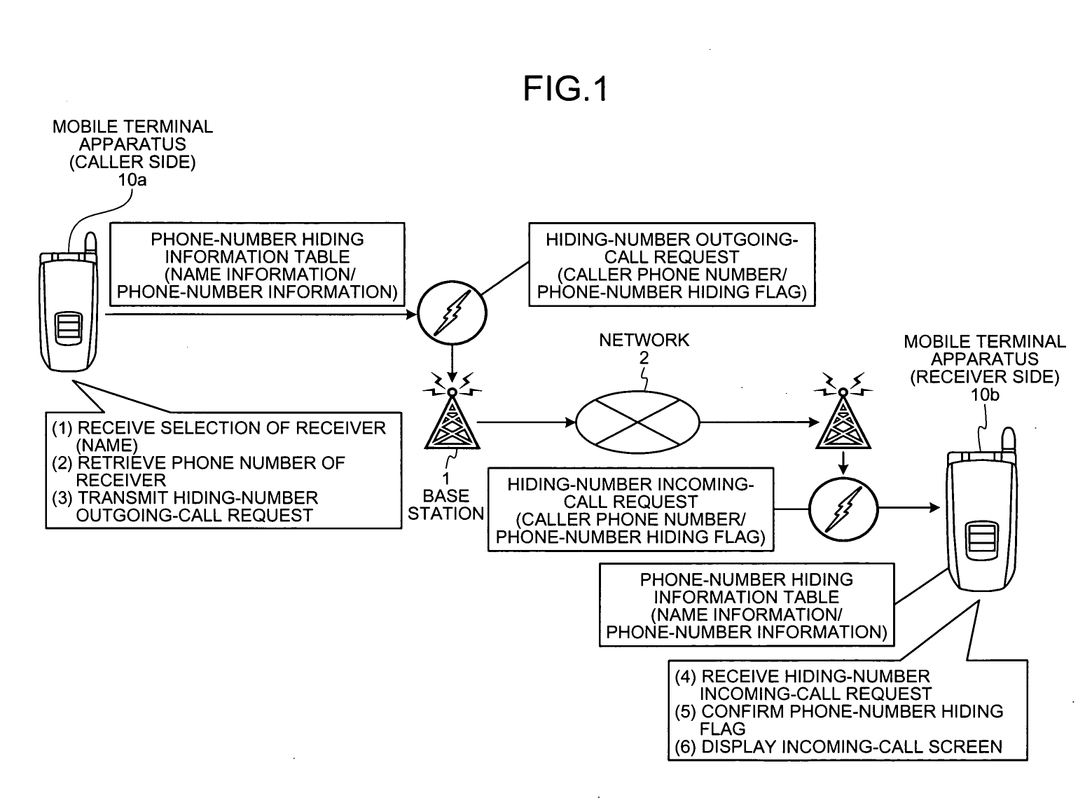

FIG. 1 is a schematic diagram for explaining an outline and characteristics of a first embodiment of the present invention.

Mobile terminal apparatuses 10a and 10b perform transmission of outgoing-call requests and reception of incoming-call requests via a network 2. In the mobile terminal apparatuses 10a and 10b, it is possible to hide information of the calling person from the receiving person thereby protecting personal information.

The mobile terminal apparatuses 10a and 10b can be a mobile communication terminal such as a cell phone terminal or a personal handyphone system (PHS) terminal. It is assumed that the users of the mobile terminal apparatuses 10a and 10b temporarily or permanently belongs to some society. The society can be a group of people having, for example, common interests, employees of a company, or students of a class of a school. Each of the mobile terminal apparatuses 10a and 10b receive various information about the other members of the society from, for example, a server of a society administrator, and creates a phone-number hiding information table by using the information received from the server. The phone-number hiding information table contains name information of the other members in association with phone-number information of mobile terminal apparatuses of the other members. The user of the mobile terminal apparatuses 10a and 10b not allowed to acquire the phone-number information of the other members from the phone-number hiding information table.

The mobile terminal apparatus 10a belongs to a calling person (caller side) and the mobile terminal apparatus 10b belongs to a receiving person (receiver side). The mobile terminal apparatus 10a transmits an outgoing-call request. For instance, when the user of the mobile terminal apparatus 10a selects the name of the user of the mobile terminal apparatus 10b from a name list of the other members displayed on a display unit such as a liquid crystal display (LCD) through a button operation (see (1) shown in FIG. 1), the mobile terminal apparatus 10a retrieves a phone number corresponding to the selected name from its own phone-number hiding information table (see (2) shown in FIG. 1). Then, the mobile terminal apparatus 10a transmits a hiding-number outgoing-call request including the phone number of the calling person (caller phone number), the retrieved phone number of the receiving person (receiver phone number), and a phone-number hiding flag to the mobile terminal apparatus 10b via a base station 1 and the network 2 (see (3) shown in FIG. 1).

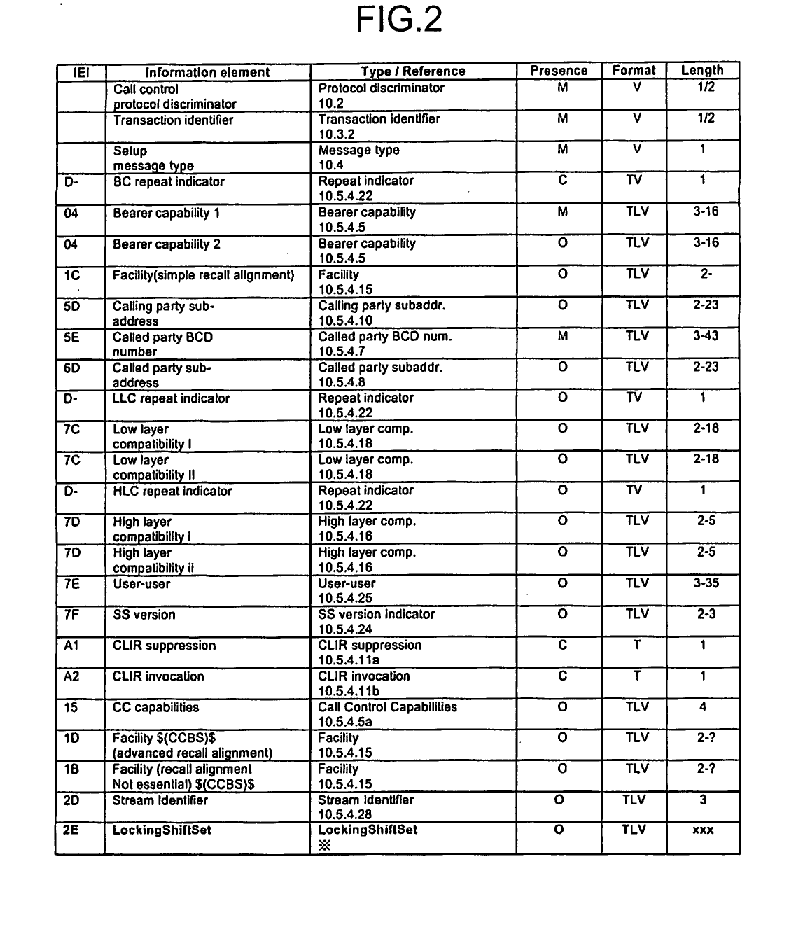

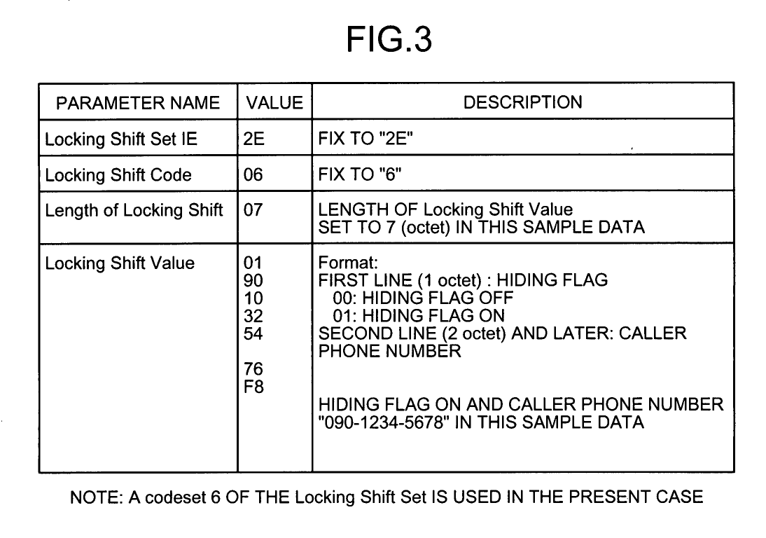

FIG. 2 depicts an example of contents of the hiding-number outgoing-call request according to the first embodiment. As shown in FIG. 2, the mobile terminal apparatus 10a creates data that functions as the hiding-number outgoing-call request by using “2E” field, in which data can be inserted, in data transmitted and received by the third generation partnership project (3GPP) that is a communication standard. FIG. 3 is a schematic diagram for explaining parameters of the hiding information according to the first embodiment. As shown in FIG. 3, the data that functions as the hiding-number outgoing-call request is created by inserting a hiding flag in the first line of a parameter “Locking Shift Value” in “2E” (“01” means that the hiding flag is “ON”, and “00” means that the hiding flag is “OFF”).

When the mobile terminal apparatus 10b receives a hiding-number incoming-call request (see (4) shown in FIG. 1), it confirms whether the phone-number hiding flag is included in the hiding-number incoming-call request (see (5) shown in FIG. 1). When the phone-number hiding flag is included in the hiding-number incoming-call request, the mobile terminal apparatus 10b retrieves a name corresponding to the caller phone number from its own phone-number hiding information table, and displays an incoming-call screen with the retrieved name on a display unit (see (6) shown in FIG. 1). When the name corresponding to the caller phone number is not stored in the phone-number hiding information table, the mobile terminal apparatus 10b displays a hiding-number call on the display unit.

In this manner, the mobile terminal apparatus 10a can make a phone call to the mobile terminal apparatus 10b without explicitly disclosing its phone number to the mobile terminal apparatus 10b. Thus, the personal information of the user of the mobile terminal apparatus 10a can be protected.

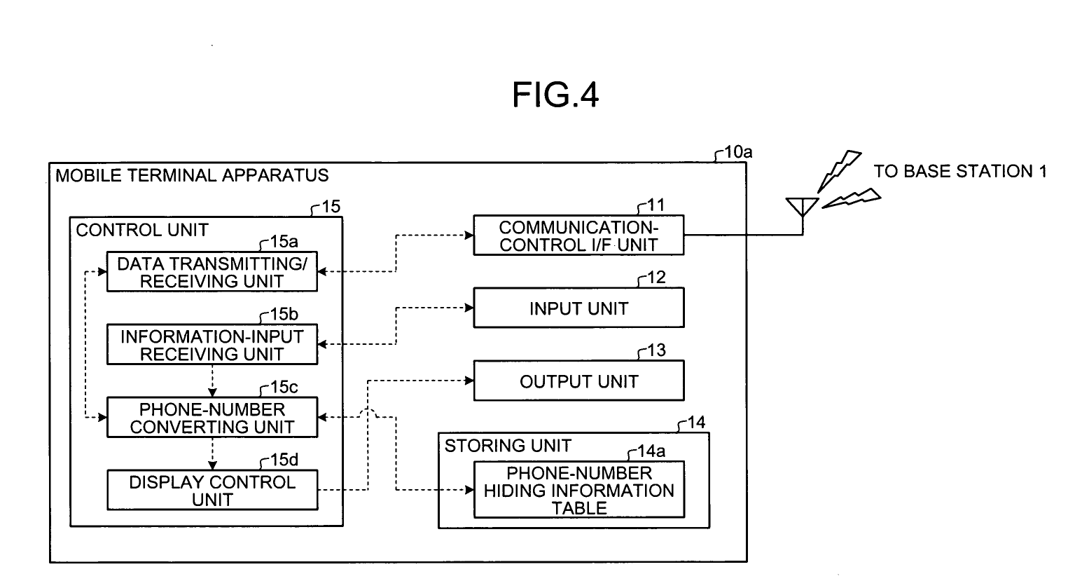

FIG. 4 is a detailed functional block diagram of the mobile terminal apparatus 10a. The mobile terminal apparatus 10b has almost the same configuration. The mobile terminal apparatus 10a includes a communication-control interface (I/F) unit 11, an input unit 12, an output unit 13, a storing unit 14, and a control unit 15.

The communication-control I/F unit 11 controls a communication to the base station 1, regarding various types of information exchanged with other mobile terminal apparatus 10b. The input unit 12 includes operation buttons and the like (not shown), and receives, for example, a selection of a name of the receiving person. The output unit 13 includes a display, a touch panel, a speaker, and the like (not shown), receives, for example, an instruction from a display control unit (not shown), and outputs a display of a name of a mobile terminal apparatus that is a transmission source of the request as an incoming-call screen.

The storing unit 14 stores therein various data and computer programs required for the control unit 15 to perform various processes. The storing unit 14 stores therein a phone-number hiding information table 14a.

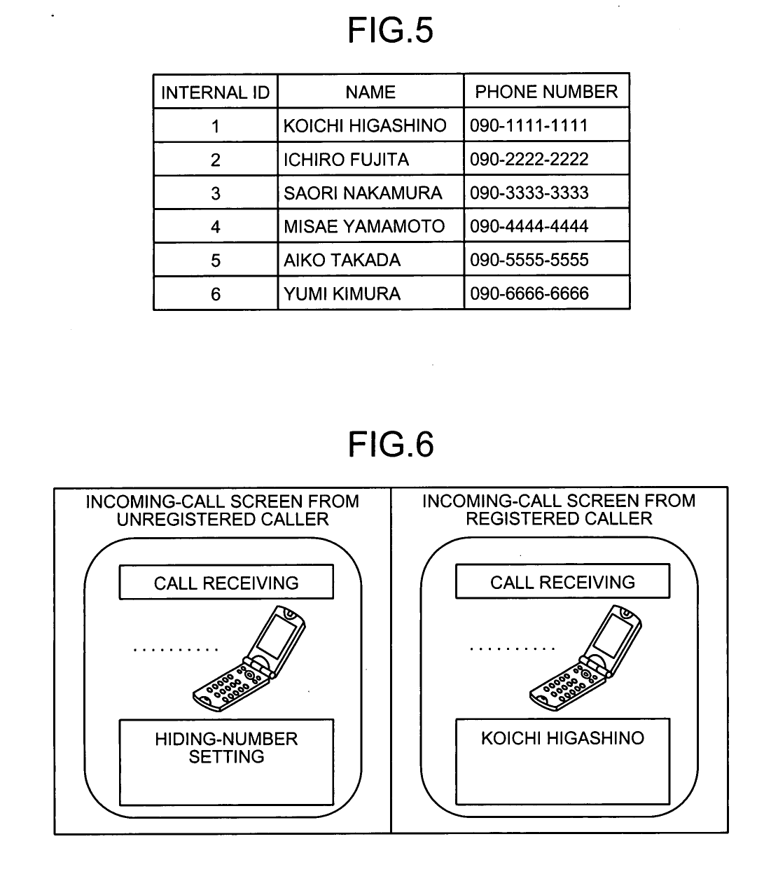

The phone-number hiding information table 14a is created in advance based on various types of information about the other members of the society to which a user belongs. The information about the other members of the society is received from, for example, a server (not shown) of a society administrator. FIG. 5 is depicts an example of contents of the phone-number hiding information table 14a. The phone-number hiding information table 14a stores therein name information about the names of the other members of the society in association with phone-number information about the phone numbers of the other members for each unique internal identification (ID) that is internally allocated.

The control unit 15 includes an internal memory (not shown) for storing a predetermined control program, computer programs for various processing procedures, and required data. The control unit 15 executes various processes using the programs and data in the internal memory. The control unit 15 includes a data transmitting/receiving unit 15a, an information-input receiving unit 15b, a phone-number converting unit 15c, and a display control unit 15d.

The data transmitting/receiving unit 15a performs transmission and reception of data through the communication-control I/F unit 11. The mobile terminal apparatus 10a receives a hiding-number incoming-call request from other mobile terminal apparatus, such as the mobile terminal apparatus 10a, via the communication-control I/F unit 11. Subsequently, the hiding-number incoming-call request is transmitted to the data transmitting/receiving unit 15a and then to the phone-number converting unit 15c. The data transmitting/receiving unit 15a creates a hiding-number outgoing-call request data including the caller phone number and the phone-number hiding flag, and transmits the created hiding-number outgoing-call request data to a receiver phone number acquired from the receiver phone-number information received from the phone-number converting unit 15c, via the communication-control I/F unit 11.

According to the first embodiment, as shown in FIG. 2, the hiding-number outgoing-call request data is created by using “2E” field, in which data can be inserted, in data transmitted and received by the 3GPP. More specifically, as shown in FIG. 3, the data that functions as the hiding-number outgoing-call request is created by inserting a hiding flag in the first line of a parameter “Locking Shift Value” in “2E” (“01” means that the hiding flag is “ON”, and “00” means that the hiding flag is “OFF”).

The information-input receiving unit 15b is a processing unit that receives a data input from the user via the input unit 12. When a selection of a name of a desired member is received from a name list of the other members displayed on the output unit 13 (for example, an LCD or a touch panel) through a button operation in the input unit 12, the information-input receiving unit 15b outputs received name information to the phone-number converting unit 15c.

The phone-number converting unit 15c performs a data processing based on the data received from the data transmitting/receiving unit 15a and the information-input receiving unit 15b. When hiding-number incoming-call request data is received from the data transmitting/receiving unit 15a, the phone-number converting unit 15c confirms whether a phone-number hiding flag is included in the hiding-number incoming-call request. When it is confirmed that the phone-number hiding flag is included in the hiding-number incoming-call request, the phone-number converting unit 15c searches name information corresponding to the caller phone number from the phone-number hiding information table 14a, acquires searched name, and outputs acquired name information on the display control unit 15d. On the other hand, when it is confirmed that the phone-number hiding flag is not included in the hiding-number incoming-call request, or when the name information corresponding to the caller phone number is not stored in the phone-number hiding information table 14a, the phone-number converting unit 15c outputs a notification that the phone-number hiding flag is not included in the hiding-number incoming-call request or that the name information corresponding to the caller phone number is not stored in the phone-number hiding information table 14a to the display control unit 15d.

In addition, when the name information is received from the information-input receiving unit 15b, the phone-number converting unit 15c searches receiver phone-number information corresponding to received name information from the phone-number hiding information table 14a, acquires searched receiver phone-number information, and outputs the receiver phone-number information to the data transmitting/receiving unit 15a.

The display control unit 15d is a processing unit that controls a data output to the output unit 13. When the name information is received from the phone-number converting unit 15c, the display control unit 15d controls the output unit 13 to display thereon received name information as an incoming-call screen. On the other hand, when the notification that the phone-number hiding flag is not included in the hiding-number incoming-call request or that the name information corresponding to the caller phone number is not stored in the phone-number hiding information table 14a is received from the phone-number converting unit 15c, the display control unit 15d controls the output unit 13 to display thereon a screen indicating a hiding-number incoming call. Then, the output unit 13 displays thereon an incoming-call screen indicating the hiding-number incoming call, as shown in FIG. 6.

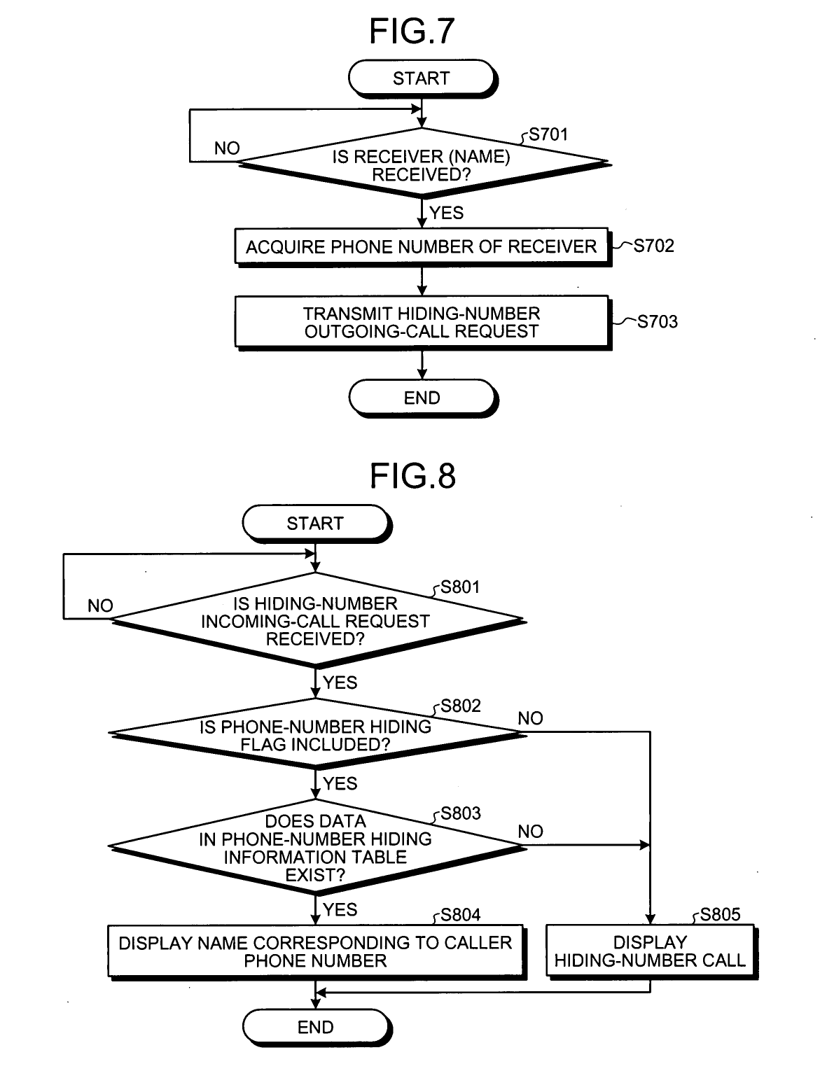

FIG. 7 is a flowchart of a process of transmitting the hiding-number outgoing-call request according to the first embodiment. FIG. 8 is a flowchart of a process of handling the hiding-number incoming-call request according to the first embodiment.

As shown in FIG. 7, when a selection of a name of a desired member is received from a name list of the other members displayed on the output unit 13 (for example, an LCD or a touch panel) through a button operation in the input unit 12 (Yes at step S701), the information-input receiving unit 15b outputs received name information to the phone-number converting unit 15c.

When the name information is received from the information-input receiving unit 15b, the phone-number converting unit 15c searches receiver phone-number information corresponding to received name information from the phone-number hiding information table 14a, acquires searched receiver phone-number information (step S702), and outputs the receiver phone-number information to the data transmitting/receiving unit 15a.

The data transmitting/receiving unit 15a creates a hiding-number outgoing-call request data including the caller phone number and the phone-number hiding flag, and transmits the created hiding-number outgoing-call request data to a receiver phone number acquired from the receiver phone-number information received from the phone-number converting unit 15c, via the communication-control I/F unit 11 (step S703).

As shown in FIG. 8, when the mobile terminal apparatus 10b receives a hiding-number incoming-call request from the mobile terminal apparatus 10a via the communication-control I/F unit 11 (Yes at step S801), the data transmitting/receiving unit 15a outputs received hiding-number incoming-call request to the phone-number converting unit 15c.

When hiding-number incoming-call request data is received from the data transmitting/receiving unit 15a, the phone-number converting unit 15c confirms whether a phone-number hiding flag is included in the hiding-number incoming-call request (step S802). When it is confirmed that the phone-number hiding flag is included in the hiding-number incoming-call request (Yes at step S802), the phone-number converting unit 15c searches name information corresponding to the caller phone number from the phone-number hiding information table 14a (step S803). When the name information corresponding to the caller phone number exists in the phone-number hiding information table 14a (Yes at step S803), the phone-number converting unit 15c acquires data on the name information from the phone-number hiding information table 14a, and outputs acquired data to the display control unit 15d.

When the name information is received from the phone-number converting unit 15c, the display control unit 15d controls the output unit 13 to display thereon received name information as an incoming-call screen. Then, the output unit 13 displays thereon a name of a user of the mobile terminal apparatus 10a that is a transmission source of the request as an incoming-call screen (step S804).

Referring back to the step S802, when it is confirmed that the phone-number hiding flag is not included in the hiding-number incoming-call request (No at step S802), the phone-number converting unit 15c outputs a notification that the phone-number hiding flag is not included in the hiding-number incoming-call request to the display control unit 15d. When the notification that the phone-number hiding flag is not included in the hiding-number incoming-call request is received from the phone-number converting unit 15c, the display control unit 15d controls the output unit 13 to display thereon a screen indicating a hiding-number incoming call. Then, the output unit 13 displays thereon an incoming-call screen indicating the hiding-number incoming call (step S805, see FIG. 6).

Referring back to the step S803, when the name information corresponding to the caller phone number does not exist in the phone-number hiding information table 14a, (No at step S803), the phone-number converting unit 15c outputs a notification that the name information corresponding to the caller phone number does not exist in the phone-number hiding information table 14a to the display control unit 15d. When the notification that the name information corresponding to the caller phone number does not exist in the phone-number hiding information table 14a is received from the phone-number converting unit 15c, the display control unit 15d controls the output unit 13 to display thereon a screen indicating a hiding-number incoming call. Then, the output unit 13 displays thereon an incoming-call screen indicating the hiding-number incoming call (step S805, see FIG. 6).

As describe above, according to the first embodiment, the name information of the user of the other mobile terminal apparatus 10b is stored in association with the phone-number information of the other mobile terminal apparatus 10b in the phone-number hiding information table 14a by receiving a distribution from a server of a society administrator or the like, when a selection of a name of other member is received as a receiver, a receiver phone number corresponding to received name is acquired from the phone-number information stored in the phone-number hiding information table 14a, an outgoing-call request including a caller phone number of the mobile terminal apparatus and a phone-number hiding flag for hiding the caller phone number is transmitted to acquired receiver phone number, when it is confirmed that the phone-number hiding flag is included in an incoming-call request, a name corresponding to a caller phone number of the other mobile terminal apparatus is acquired from the name information stored in the phone-number hiding information table 14a, and a display unit is controlled to display thereon acquired name only. Therefore, it is possible to make a phone call without explicitly telling the phone number to the other side between members of a predetermined society sharing the phone-number hiding information table. In addition, because the caller phone number is not displayed on the display unit when receiving a call, the personal information such as the phone number can be protected.

Although the first embodiment explained a case in which the name information of the other member is stored in association with the phone number of the mobile terminal apparatus 10b used by the other member in the phone-number hiding information table 14a, the present invention is not limited to this scheme. The phone-number hiding information table 14a can further store therein an expiration date of the name information and the phone-number information, which will be explained in a second embodiment of the present invention.

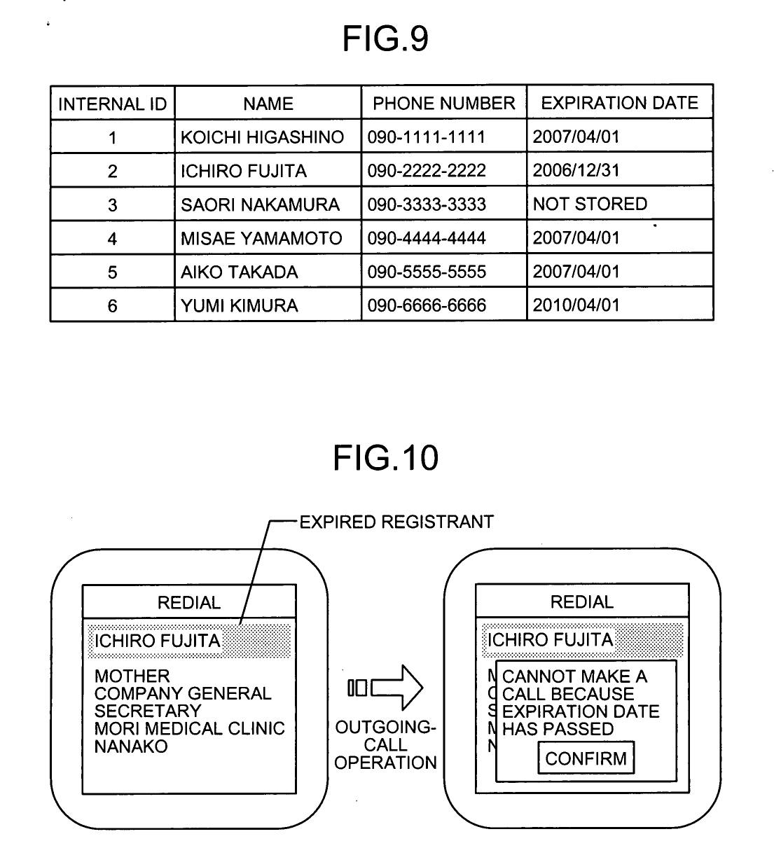

FIG. 9 is a schematic diagram for explaining an example of data configuration of a phone-number hiding information table according to the second embodiment. FIG. 10 is a schematic diagram for explaining an image of a screen when the expiration date has passed for a registrant according to the second embodiment. A mobile terminal apparatus according to the second embodiment has the same configuration (function) for the communication-control I/F unit 11, the input unit 12, the output unit 13, the data transmitting/receiving unit 15a and the information-input receiving unit 15b of the control unit 15, as the mobile terminal apparatuses 10a and 10b according to the first embodiment. However, the phone-number hiding information table 14a of the storing unit 14 and the phone-number converting unit 15c and the display control unit 15d of the control unit 15 are different.

According to the second embodiment, the phone-number hiding information table 14a not only stores the name information of the other member is stored in association with the phone number of the other member, but also stores an expiration date of the name information and the phone-number information, as shown in FIG. 9. The expiration date of the name information and the phone-number information is set in advance and distributed by a server of a society administrator or the like at a time of entering a predetermined society.

When the name information is received from the information-input receiving unit 15b, the phone-number converting unit 15c searches a receiver phone-number information corresponding to received name information and an expiration date of the receiver phone number, acquires searched receiver phone-number information and expiration date, and confirms whether acquired receiver phone number is within the expiration date. When it is confirmed that the expiration date of the acquired receiver phone number is valid, the phone-number converting unit 15c outputs the receiver phone number to the data transmitting/receiving unit 15a. On the other hand, when it is confirmed that the expiration date of the acquired receiver phone number has passed, the phone-number converting unit 15c outputs a notification that the expiration date of the acquired receiver phone number has passed to the display control unit 15d.

When hiding-number incoming-call request data is received from the data transmitting/receiving unit 15a, the phone-number converting unit 15c confirms whether a phone-number hiding flag is included in the hiding-number incoming-call request. When it is confirmed that the phone-number hiding flag is included in the hiding-number incoming-call request, the phone-number converting unit 15c searches name information corresponding to the caller phone number from the phone-number hiding information table 14a. When data of the name information corresponding to the caller phone number exists in the phone-number hiding information table 14a, the phone-number converting unit 15c further confirms whether the expiration date of the name information is valid. When it is confirmed that the expiration date of the name information is valid, the phone-number converting unit 15c acquires data of the name information corresponding to the caller phone number from the phone-number hiding information table 14a, and outputs acquired name information to the display control unit 15d.

On the other hand, when it is confirmed that the expiration date of the name information has passed, the output unit 13 is controlled to display thereon an incoming-call screen indicating the hiding-number incoming call, in the same manner as the first embodiment.

When the notification that the expiration date of the acquired receiver phone number has passed is received from the phone-number converting unit 15c, the display control unit 15d controls the output unit 13 to display thereon a screen indicating that the expiration date of the acquired receiver phone number has passed. Then, the output unit 13 displays thereon the screen indicating that the expiration date of the acquired receiver phone number has passed, as shown in FIG. 10.

When the expiration date of the data of the name information searched from the phone-number hiding information table 14a has passed, the display control unit 15d controls the output unit 13 to display thereon a screen indicating a hiding-number incoming call. Then, the output unit 13 displays thereon an incoming-call screen indicating the hiding-number incoming call, as shown in FIG. 6.

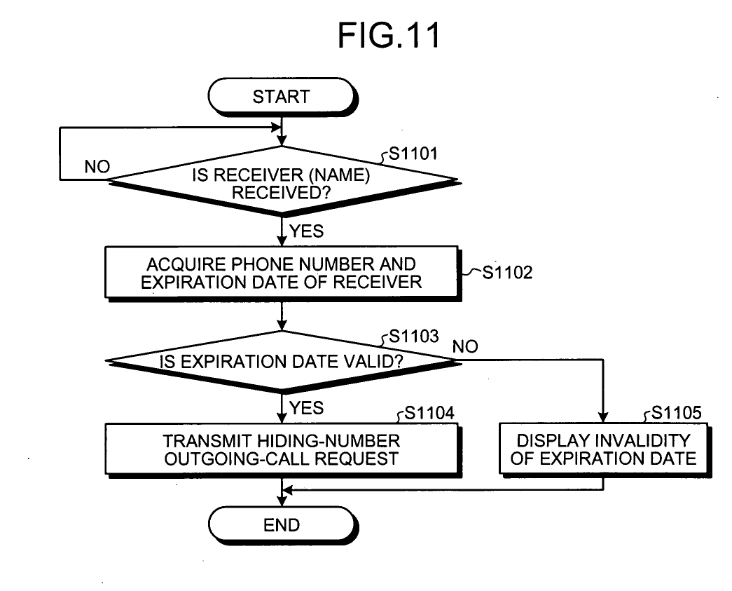

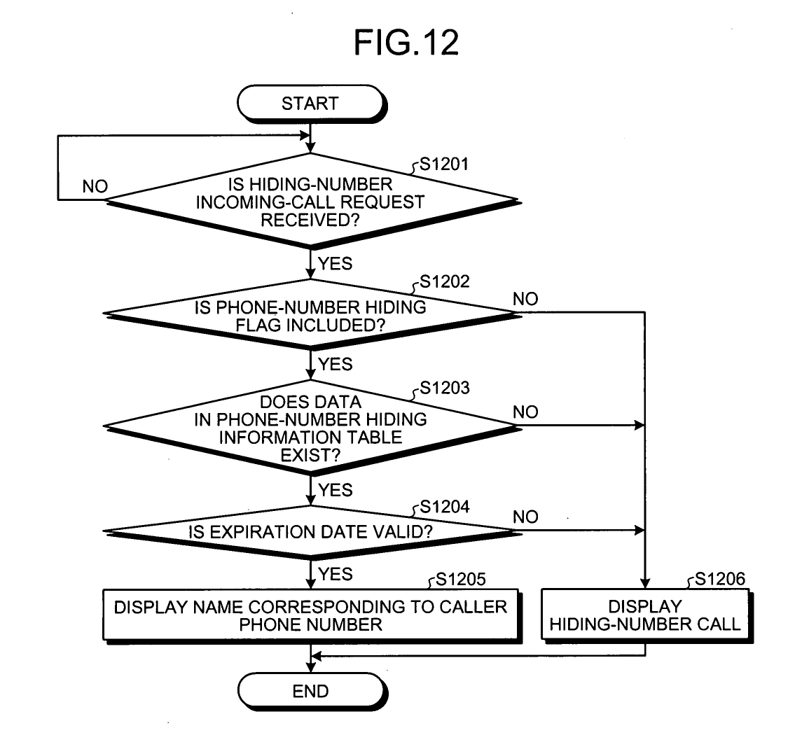

FIG. 11 is a flowchart of a process of transmitting the hiding-number outgoing-call request according to the second embodiment. FIG. 12 is a flowchart of a process of handling the hiding-number incoming-call request according to the second embodiment.

As shown in FIG. 11, when a selection of a name of a desired member is received from a name list of the other members displayed on the output unit 13 (for example, an LCD or a touch panel) through a button operation in the input unit 12 (Yes at step S1101), the information-input receiving unit 15b outputs received name information to the phone-number converting unit 15c. So far, the process is the same as the hiding-number outgoing-call request transmitting process according to the first embodiment (see step S701 shown in FIG. 7).

When the name information is received from the information-input receiving unit 15b, the phone-number converting unit 15c searches receiver phone-number information corresponding to received name information and an expiration date of the receiver phone number from the phone-number hiding information table 14a, and acquires searched receiver phone-number information and expiration date (step S1102).

Then, the phone-number converting unit 15c confirms whether acquired receiver phone number is within the expiration date (step S1103). When it is confirmed that the expiration date of the acquired receiver phone number is valid (Yes at step S1103), the phone-number converting unit 15c outputs the receiver phone number to the data transmitting/receiving unit 15a. Then, the data transmitting/receiving unit 15a creates a hiding-number outgoing-call request data including the caller phone number and the phone-number hiding flag, and transmits the created hiding-number outgoing-call request data to a receiver phone number acquired from the receiver phone-number information received from the phone-number converting unit 15c, via the communication-control I/F unit 11 (step S1104), in the same manner as the hiding-number outgoing-call request transmitting process according to the first embodiment (see step S703 shown in FIG. 7).

On the other hand, when it is confirmed that the expiration date of the acquired receiver phone number has passed (No at step S1103), the phone-number converting unit 15c outputs a notification that the expiration date of the acquired receiver phone number has passed to the display control unit 15d. When the notification that the expiration date of the acquired receiver phone number has passed is received from the phone-number converting unit 15c, the display control unit 15d controls the output unit 13 to display thereon a screen indicating that the expiration date of the acquired receiver phone number has passed. Then, the output unit 13 displays thereon the screen indicating that the expiration date of the acquired receiver phone number has passed, as shown in FIG. 10 (step S1105).

As shown in FIG. 12, when the mobile terminal apparatus 10b receives a hiding-number incoming-call request from the mobile terminal apparatus 10a via the communication-control I/F unit 11 (Yes at step S1201), the data transmitting/receiving unit 15a of the mobile terminal apparatus 10b outputs received hiding-number incoming-call request to the phone-number converting unit 15c.

When hiding-number incoming-call request data is received from the data transmitting/receiving unit 15a, the phone-number converting unit 15c confirms whether a phone-number hiding flag is included in the hiding-number incoming-call request (step S1202). When it is confirmed that the phone-number hiding flag is included in the hiding-number incoming-call request (Yes at step S1202), the phone-number converting unit 15c searches name information corresponding to the caller phone number from the phone-number hiding information table 14a (step S1203). So far, the process is the same as the hiding-number incoming-call request handling process according to the first embodiment (see steps S801 to S803 shown in FIG. 8)

When the name information corresponding to the caller phone number exists in the phone-number hiding information table 14a, the phone-number converting unit 15c further confirms whether the expiration date of the name information is valid (step S1204). When it is confirmed that the expiration date of the name information is valid (Yes at step S1204), the phone-number converting unit 15c acquires data of the name information corresponding to the caller phone number from the phone-number hiding information table 14a, and outputs acquired name information to the display control unit 15d.

After that, in the same manner as the hiding-number incoming-call request handling process according to the first embodiment (see step S804 shown in FIG. 8), when the name information is received from the phone-number converting unit 15c, the display control unit 15d controls the output unit 13 to display thereon received name information as an incoming-call screen. Then, the output unit 13 displays thereon a name of a user of the mobile terminal apparatus 10a that is a transmission source of the request as an incoming-call screen (step S1205).

Referring back to the step S1204, when it is confirmed that the expiration date of the name information has passed (No at step S1204), the phone-number converting unit 15c outputs a notification that the expiration date of the name information has passed to the display control unit 15d.

When the notification that the expiration date of the name information has passed is received from the phone-number converting unit 15c, the display control unit 15d controls the output unit 13 to display thereon a screen indicating a hiding-number incoming call. Then, the output unit 13 displays thereon an incoming-call screen indicating the hiding-number incoming call (step S1206), in the same manner as the hiding-number incoming-call request handling process according to the first embodiment (see step S805 shown in FIG. 8).

Referring back to the step 1202, when it is confirmed that the phone-number hiding flag is not included in the hiding-number incoming-call request (No at step S1202), the phone-number converting unit 15c outputs a notification that the phone-number hiding flag is not included in the hiding-number incoming-call request to the display control unit 15d. When the notification that the phone-number hiding flag is not included in the hiding-number incoming-call request is received from the phone-number converting unit 15c, the display control unit 15d controls the output unit 13 to display thereon a screen indicating a hiding-number incoming call. Then, the output unit 13 displays thereon an incoming-call screen indicating the hiding-number incoming call (step S1206), in the same manner as the hiding-number incoming-call request handling process according to the first embodiment (see step S805 shown in FIG. 8).

Referring back to the step S1203, when the name information corresponding to the caller phone number does not exist in the phone-number hiding information table 14a (No at step S1203), the phone-number converting unit 15c outputs a notification that the name information corresponding to the caller phone number does not exist in the phone-number hiding information table 14a to the display control unit 15d. When the notification that the name information corresponding to the caller phone number does not exist in the phone-number hiding information table 14a is received from the phone-number converting unit 15c, the display control unit 15d controls the output unit 13 to display thereon a screen indicating a hiding-number incoming call. Then, the output unit 13 displays thereon an incoming-call screen indicating the hiding-number incoming call (step S1206), in the same manner as the hiding-number incoming-call request handling process according to the first embodiment (see step S805 shown in FIG. 8).

As described above, according to the second embodiment, an expiration date of the name information and the phone-number information is further stored, when it is confirmed that the expiration date of the acquired receiver phone number is valid, the outgoing-call request is transmitted to the acquired receiver phone number, and when it is confirmed that the expiration date of the acquired receiver phone number has passed, the display unit is controlled to display thereon a hiding-number call. Therefore, when a person belongs to a society such as a specific group or circle of a company or a class of a school for a specific period, even if a contact address such as the phone number is disclosed to specific members for the purpose of an emergency contact, because it is possible to automatically disable a communication to an expired contact address and to display a hiding-number call, the personal information can be protected to a satisfactory extent.

In addition, the data stored in the phone-number hiding information table 14a that is prepared in advance in the mobile terminal apparatuses 10a and 10b according to the first and the second embodiment can be newly registered, edited, and deleted as required, which will be explained in a third embodiment of the present invention.

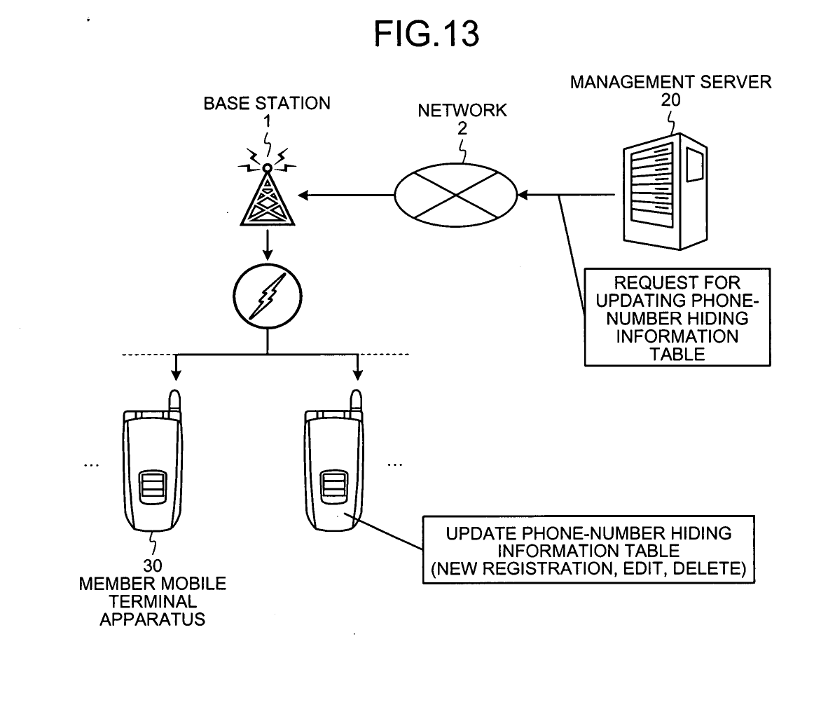

FIG. 13 is a schematic diagram for explaining an outline and characteristics of a mobile terminal apparatus according to the third embodiment. As shown in FIG. 13, the mobile terminal apparatus according to the third embodiment (for example, a member mobile terminal apparatus 30) receives various types of information on the other member of a society to which a user of the member mobile terminal apparatus 30 belongs (for example, a society to which the user belongs for a specific period, such as a specific group or circle of a company or a class of a school) from a server of a society administrator (for example, a management server 20), and creates in advance a phone-number hiding information table for storing name information of the other member in association with phone-number information of a mobile terminal apparatus of the other member, based on the information received from the management server 20. Furthermore, the member mobile terminal apparatus 30 can perform a new registration, an edit, and a delete of personal information via a network distribution from the management server 20.

When a request for updating a phone-number hiding information table including update data is received from the management server 20 via the network 2 and the base station 1, the member mobile terminal apparatus 30 checks if there is the phone-number hiding information table 14a in the storing unit 14. When there is the phone-number hiding information table 14a, the member mobile terminal apparatus 30 updates the phone-number hiding information table 14a based on the update data included in received request for updating the phone-number hiding information table. Upon completing the update of the phone-number hiding information table 14a, the member mobile terminal apparatus 30 transmits a notification of completing the update to the management server 20 via the network 2 and the base station 1.

In this manner, according to the third embodiment, it is possible to perform an update of the table data, such as the new registration, the edit, and the delete of the personal information, via the network distribution, so that the personal information can be managed according to the number of members and a policy of the society. At the same time, the personal information can be protected by suppressing a risk such as a leakage of the personal information in a minimum extent.

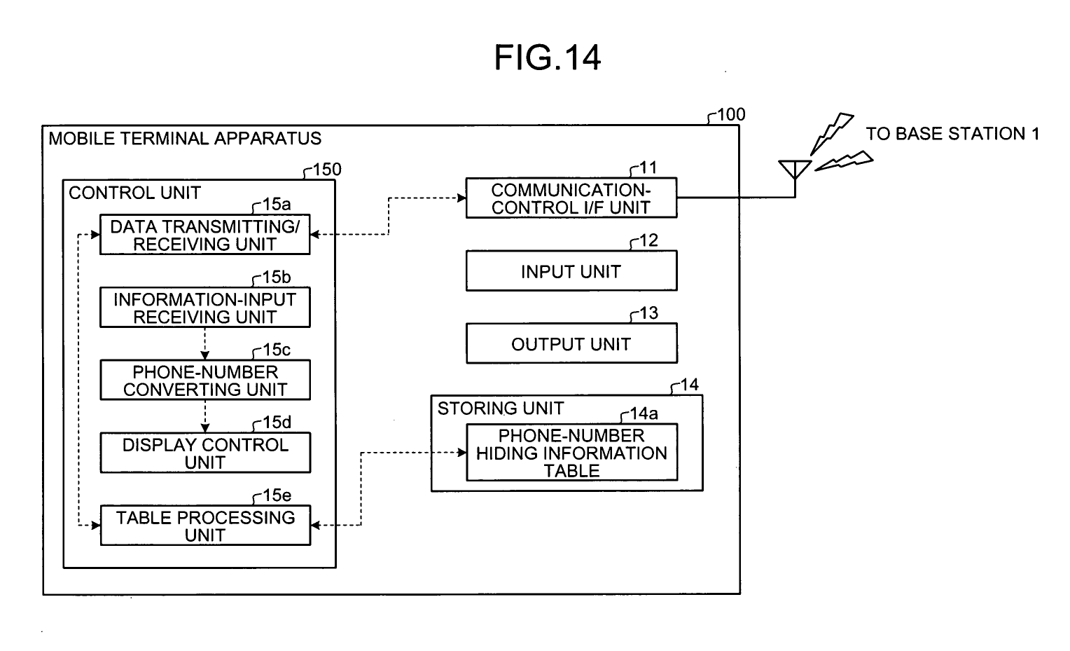

FIG. 14 is a detailed functional block diagram of a mobile terminal apparatus 100 according to the third embodiment. The mobile terminal apparatus 100 includes a table processing unit 15e in the control unit 150, in addition to the communication-control I/F unit 11, the input unit 12, the output unit 13, the storing unit 14, and the data transmitting/receiving unit 15a, the information-input receiving unit 15b, the phone-number converting unit 15c, and the display control unit 15d of the control unit 150.

The table processing unit 15e is a processing unit that performs, when the request for updating the phone-number hiding information table is received from the management server 20 by the data transmitting/receiving unit 15a, a new registration, an edit, and a delete of data in the phone-number hiding information table 14a.

When the request for updating the phone-number hiding information table including the update data is received from the management server 20 via the network 2 and the base station 1, the table processing unit 15e checks if there is the phone-number hiding information table 14a in the storing unit 14. When there is the phone-number hiding information table 14a, the table processing unit 15e updates the phone-number hiding information table 14a based on the update data included in received request for updating the phone-number hiding information table.

On the other hand, when there is no phone-number hiding information table in the storing unit 14, for example, as a new registrant, the table processing unit 15e creates a phone-number hiding information table, and after that, updates the phone-number hiding information table based on the update data included in received request for updating the phone-number hiding information table.

Upon completing the update of the phone-number hiding information table 14a, the table processing unit 15e transmits a notification of completing the update to the data transmitting/receiving unit 15a. When the notification of completing the update is received, the data transmitting/receiving unit 15a transmits the notification of completing the update to the management server 20 via the network 2 and the base station 1.

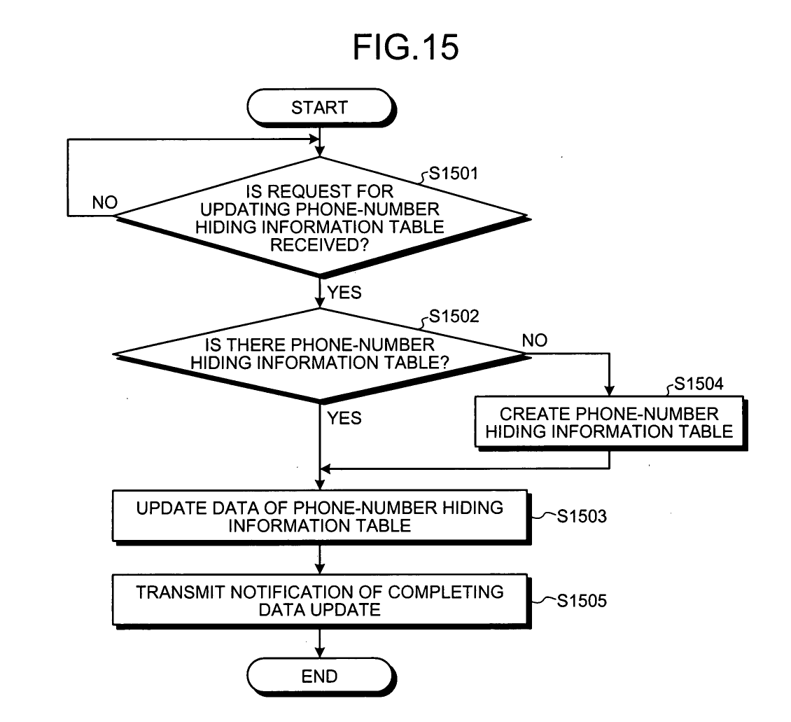

FIG. 15 is a flowchart of a process of updating the phone-number hiding information table according to the third embodiment. As shown in FIG. 15, when a request for updating a phone-number hiding information table including update data is received from the management server 20 via the network 2 and the base station 1 (Yes at step S1501), the table processing unit 15e checks if there is the phone-number hiding information table 14a in the storing unit 14 (step S1502).

When there is the phone-number hiding information table 14a in the storing unit 14 (Yes at step S1502), the table processing unit 15e updates the phone-number hiding information table 14a based on the update data included in received request for updating the phone-number hiding information table (step S1503).

On the other hand, when there is no phone-number hiding information table in the storing unit 14, for example, as a new registrant (No at step S1502), the table processing unit 15e creates a phone-number hiding information table (step S1504), and after that, updates the phone-number hiding information table based on the update data included in received request for updating the phone-number hiding information table (step S1503).

Upon completing the update of the phone-number hiding information table 14a, the table processing unit 15e transmits a notification of completing the update to the data transmitting/receiving unit 15a. When the notification of completing the update is received, the data transmitting/receiving unit 15a transmits the notification of completing the update to the management server 20 via the network 2 and the base station 1 (step S1505).

Although the phone-number hiding information table 14a is updated by receiving the request for updating the phone-number hiding information table from the management server 20 via the network 2 according to the third embodiment, the present invention is not limited to this scheme. For instance, the phone-number hiding information table 14a can be updated by using an external medium that can be connected to the mobile terminal apparatus 100, such as a universal serial bus (USB) memory and a USB flash memory.

As describe above, according to the third embodiment, because a new registration, an edit, and a delete of the name information, the phone-number information, and the expiration date can be made, with respect to the phone-number hiding information table 14a, for example, the management server 20 that is managed by a society such as a specific group or circle of a company or a class of a school can collectively manage a registration, an edit, and a delete of the personal information, and it is possible to reflect an update of data, such as the registration, the edit, and the delete of the personal information, on mobile terminal apparatuses used by members of the society via a network distribution or an external medium, so that the personal information can be managed according to the number of members and a policy of the society. At the same time, the personal information can be protected by suppressing a risk such as a leakage of the personal information in a minimum extent.

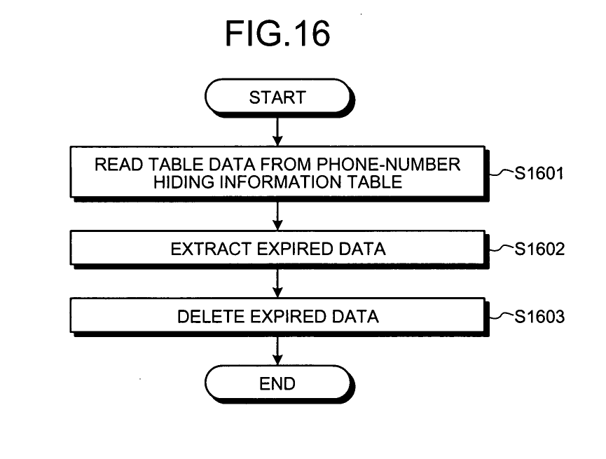

Regarding the name information and the phone-number information stored in the phone-number hiding information table 14a, a confirmation whether the expiration date has passed can be performed at regular intervals, and when it is confirmed that the expiration date has passed, the name information and the phone-number information for which the expiration date has passed can be deleted. A process of automatically deleting the table data performed with the confirmation of the expiration date executed in the mobile terminal apparatus 100 at regular intervals will be explained with reference to FIG. 16. FIG. 16 is a flowchart of the process of automatically deleting the table data from the phone-number hiding information table according to a fourth embodiment of the present invention.

As shown in FIG. 16, when it comes to a periodic timing for executing the confirmation of the expiration date of the phone-number hiding information table 14a, the table processing unit 15e executes a read of the table data from the phone-number hiding information table 14a (step S1601).

After reading the table data, the table processing unit 15e checks the expiration date of read table data, and when there is expired data, extracts the expired data from the read table data (step S1602). If there is no expired data, the table processing unit 15e ends the process as it is.

Then, the table processing unit 15e deletes extracted expired data (step S1603), and stores the read table data in the phone-number hiding information table 14a.

In this manner, because a confirmation whether the expiration date has passed is performed at regular intervals, and when it is confirmed that the expiration date has passed, the name information and the phone-number information for which the expiration date has passed is deleted, regarding the name information and the phone-number information stored in the phone-number hiding information table 14a, it is possible to save a storage capacity of the mobile terminal apparatus 100.

Each of the units of the mobile terminal apparatus according to the embodiments is conceptual in terms of the function, and is not necessarily to be physically configured as shown in the figures. In other words, a detailed scheme of partitioning and integrating the units of the mobile terminal apparatuses according to the embodiments is not limited to the one shown in the figure, but all of or a part of the units can be partitioned or integrated functionally or physically in arbitrary units depending on various loads and usage condition. For instance, the information-input receiving unit 15b and the phone-number converting unit 15c shown in FIG. 4 can be integrated, and the phone-number converting unit 15c and the table processing unit 15e shown in FIG. 14 can be integrated as required.

Furthermore, a whole of or a part of the process functions performed in the mobile terminal apparatuses according to the embodiments (such as the hiding-number outgoing-call request transmitting process function explained with FIGS. 7 and 11, the hiding-number incoming-call request handling process function explained with FIGS. 8 and 12, the phone-number hiding information updating process function explained with FIG. 15, and the automatic table-data deleting process function explained with FIG. 16) can be realized by a central processing unit (CPU) and programs executed by the CPU, or by a hardware configured with a wired logic.

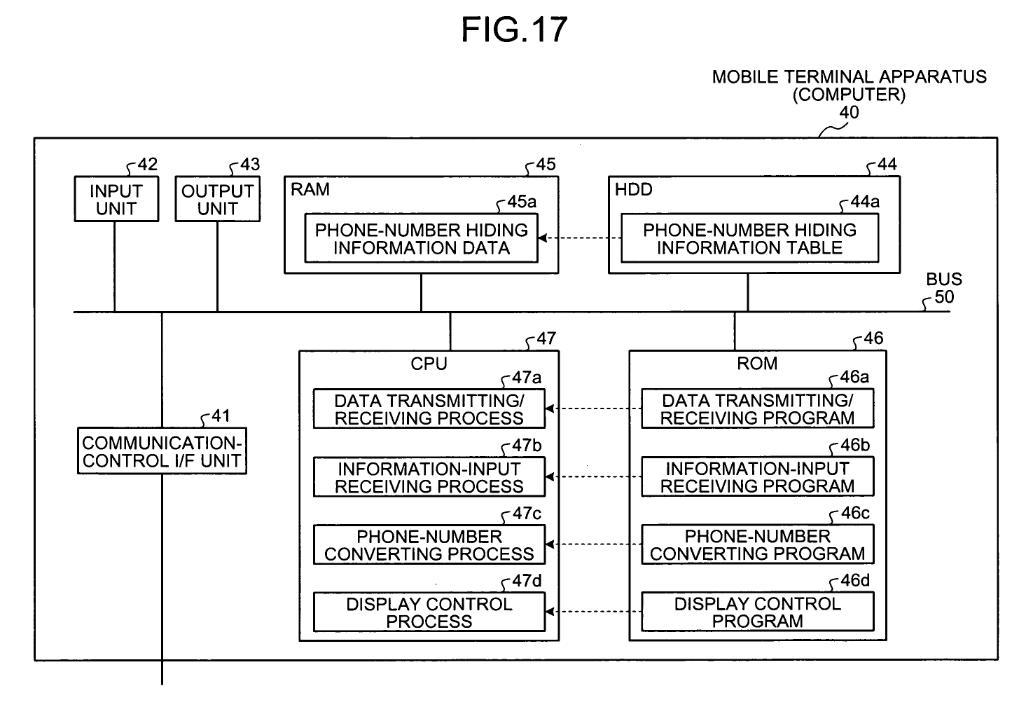

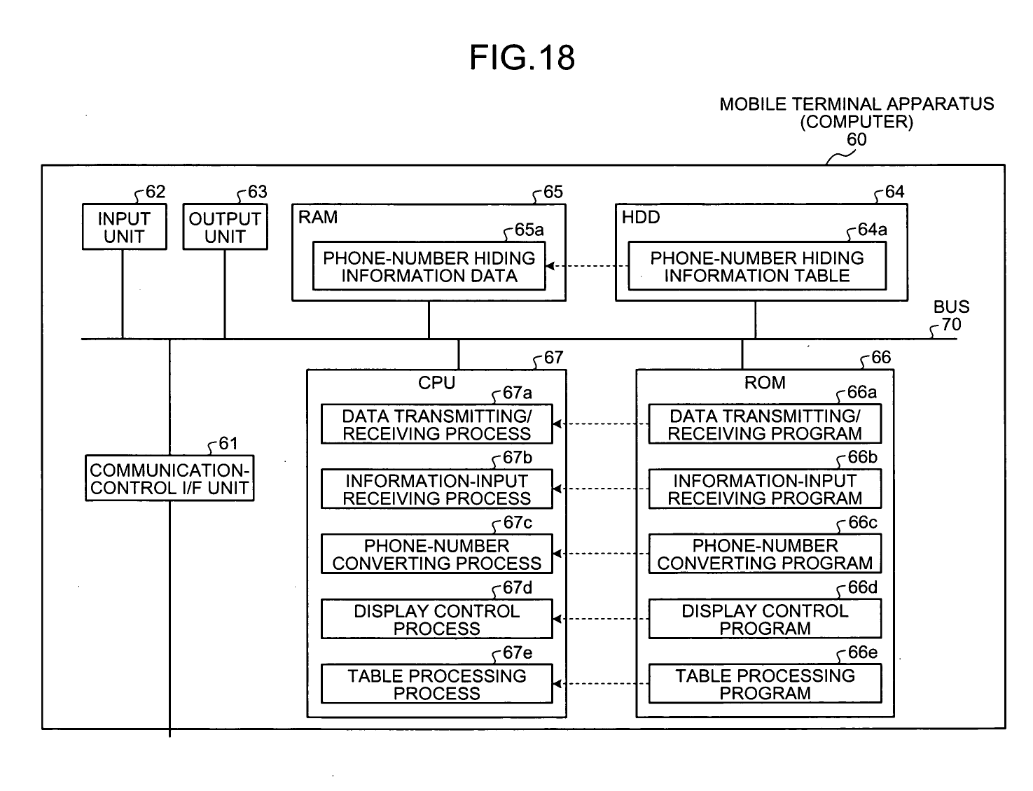

The processes of the mobile terminal apparatus according to the embodiments (see FIGS. 7, 8, 11, 12, 15, and 16) can be realized by executing a program prepared in advance in a computer system such as a personal computer and a workstation, and by executing an application program prepared in advance in the mobile terminal apparatus according to the embodiments. FIG. 17 is a functional block diagram of a computer 40 that executes a request transmission/reception control program according to the first and the second embodiments. FIG. 18 is a functional block diagram of a computer 60 that executes a request transmission/reception control program according to the third and the fourth embodiments.

As shown in FIG. 17, the computer 40 is configured by connecting a communication-control I/F unit 41, an input unit 42, an output unit 43, a hard disk drive (HDD) 44, a random access memory (RAM) 45, a read only memory (ROM) 46, and a CPU 47, with a bus 50. The communication-control I/F unit 41, the input unit 42, and the output unit 43 correspond to the communication-control I/F unit 11, the input unit 12, and the output unit 13 shown in FIG. 4, respectively.

In the ROM 46, a request-transmission/reception control program that brings out the same function as the mobile terminal apparatus according to the embodiments, i.e., a data transmitting/receiving program 46a, an information-input receiving program 46b, a phone-number converting program 46c, and a display control program 46d are stored in advance, as shown in FIG. 17. Regarding the programs 46a, 46b, 46c, and 46d, a partitioning and an integrating can be performed as required, in the same manner as the units of the mobile terminal apparatus 10a shown in FIG. 4. In addition, the ROM 46 can be substituted by a nonvolatile RAM.

As the CPU 47 reads out and executes the programs 46a, 46b, 46c, and 46d, the programs 46a, 46b, 46c, and 46d function as a data transmitting/receiving process 47a, an information-input receiving process 47b, a phone-number converting process 47c, and a display control process 47d, respectively, as shown in FIG. 17. The processes 47a, 47b, 47c, and 47d correspond to the data transmitting/receiving unit 15a, the information-input receiving unit 15b, the phone-number converting unit 15c, and the display control unit 15d shown in FIG. 4, respectively.

In the HDD 44, a phone-number hiding information table 44a is stored, as shown in FIG. 17. The phone-number hiding information table 44a corresponds to the phone-number hiding information table 14a shown in FIG. 4. The CPU 47 reads out phone-number hiding information data 45a from the phone-number hiding information table 44a, stores the phone-number hiding information data 45a in the RAM 45, and executes the request-transmission/reception control process based on the phone-number hiding information data 45a stored in the RAM 45.

The programs 46a, 46b, 46c, and 46d are not necessarily to be stored in the ROM 46. For instance, the programs 46a, 46b, 46c, and 46d can be stored in “a removable physical medium” that can be inserted into the computer 40, such as a flexible disk (FD), a compact disk-read only memory (CD-ROM), a digital versatile disk (DVD), an optical-magnetic disk, and an integrated-circuit (IC) card, “a fixed physical medium” such as an HDD provided internally and externally to the computer 40, and “other computer (or a server)” that is connected to the computer 40 via a public line, the Internet, a local area network (LAN), and a wide area network (WAN), so that the computer 40 can read out and execute the programs.

As shown in FIG. 18, the computer 60 is configured by connecting a communication-control I/F unit 61, an input unit 62, an output unit 63, an HDD 64, a RAM 65, a ROM 66, and a CPU 67, with a bus 70. The communication-control I/F unit 61, the input unit 62, and the output unit 63 correspond to the communication-control I/F unit 11, the input unit 12, and the output unit 13 shown in FIG. 14, respectively.

In the ROM 66, a request-transmission/reception control program that brings out the same function as the mobile terminal apparatus 10a, i.e., a data transmitting/receiving program 66a, an information-input receiving program 66b, a phone-number converting program 66c, a display control program 66d, and a table processing program 66e are stored in advance, as shown in FIG. 18. Regarding the programs 66a, 66b, 66c, 66d, and 66e, a partitioning and an integrating can be performed as required, in the same manner as the units of the mobile terminal apparatus 100 shown in FIG. 14. In addition, the ROM 66 can be substituted by a nonvolatile RAM.

As the CPU 67 reads out and executes the programs 66a, 66b, 66c, 66d, and 66e, the programs 66a, 66b, 66c, 66d, and 66e function as a data transmitting/receiving process 67a, an information-input receiving process 67b, a phone-number converting process 67c, a display control process 67d, and a table processing process 67e, respectively, as shown in FIG. 18. The processes 67a, 67b, 67c, 67d and 67e correspond to the data transmitting/receiving unit 15a, the information-input receiving unit 15b, the phone-number converting unit 15c, the display control unit 15d, and the table processing unit 15e shown in FIG. 14, respectively.

In the HDD 64, a phone-number hiding information table 64a is stored, as shown in FIG. 18. The phone-number hiding information table 64a corresponds to the phone-number hiding information table 14a shown in FIG. 14. The CPU 67 reads out phone-number hiding information data 65a from the phone-number hiding information table 64a, stores the phone-number hiding information data 65a in the RAM 65, and executes the request-transmission/reception control process based on the phone-number hiding information data 65a stored in the RAM 65.

The programs 66a, 66b, 66c, 66d, and 66e are not necessarily to be stored in the ROM 66. For instance, the programs 66a, 66b, 66c, 66d, and 66e can be stored in “a removable physical medium” that can be inserted into the computer 60, such as an FD, a CD-ROM, a DVD, an optical-magnetic disk, and an IC card, “a fixed physical medium” such as an HDD provided internally and externally to the computer 60, and “other computer (or a server)” that is connected to the computer 60 via a public line, the Internet, a LAN, and a WAN, so that the computer 60 can read out and execute the programs.

Although the above embodiments explained a case in which the various process functions are performed in the mobile terminal apparatus, the present invention is not limited to this scheme. For instance, the

For instance, the hiding-number outgoing-call request transmitting process function (see FIGS. 7 and 11) and the hiding-number incoming-call request handling process function (see FIGS. 8 and 12) can be provided in a telephone switching equipment that performs a communication with a base station.

In this case the mobile terminal apparatus includes a table that stores therein name information of other member in association with scrambled information in which a scramble is performed on phone-number information of a mobile terminal apparatus used by the other member. The telephone switching equipment includes a table that stores therein name information of a user of a mobile terminal apparatus in association with phone-number information of the mobile terminal apparatus, with a function of descrambling the scrambled information.

Upon receiving a selection of a name of a receiver from a user, the mobile terminal apparatus extracts scrambled information corresponding to selected name, and transmits an outgoing-call request including extracted scrambled information. When the outgoing-call request is received, the telephone switching equipment specifies a receiver phone number by descrambling the scrambled information included in the outgoing-call request, and extracts name information corresponding to a caller phone number in the outgoing-call request. After that, the telephone switching equipment transfers the outgoing-call request to specified receiver phone number, and controls a display unit (such as an LCD) of a mobile terminal apparatus, on which an incoming-call screen is displayed, to display a name that is indicated by extracted name information.

In this manner, by applying the function of the mobile terminal apparatus according to the present invention to other equipment (such as the telephone switching equipment), it is possible to eliminate a necessity of maintaining actual phone-number information of the other member in the mobile terminal apparatus, and to prevent a leakage of personal information in a positive manner.

As describe above, according to an aspect of the present invention, it is possible to make a phone call without explicitly disclosing the phone number to the receiving person thereby protecting the personal information of member of a society.

Furthermore, it is possible to automatically disable a communication to an expired contact address and to display a hiding-number call.

Moreover, it is possible to prevent leakage of the personal information.

Furthermore, it is possible to reduce storage capacity of the mobile terminal apparatus.

Although the invention has been described with respect to a specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A mobile terminal apparatus that performs transmission of an outgoing-call request to and reception of an incoming-call request from other mobile terminal apparatus via a network, the mobile terminal apparatus comprising:
a phone-number-information storing unit that stores therein name information of a user of the other mobile terminal apparatus in association with phone-number information unique to the other mobile terminal apparatus;
a receiver-phone-number acquiring unit that acquires, when a name of the user of the other mobile terminal apparatus is received from a user of the mobile terminal apparatus, a receiver phone number corresponding to received name from the phone-number information stored in the phone-number-information storing unit;
an outgoing-call-request transmitting unit that transmits an outgoing-call request including a caller phone number of the mobile terminal apparatus and a phone-number hiding flag for hiding the caller phone number to acquired receiver phone number via the network;
an incoming-call-request receiving unit that receives an outgoing-call request transmitted from the other mobile terminal apparatus via the network as an incoming-call request;
a phone-number-hiding-flag confirming unit that confirms whether a phone-number hiding flag is included in received incoming-call request;
a name-information acquiring unit that acquires, when it is confirmed that the phone-number hiding flag is included in the received incoming-call request, a name corresponding to a caller phone number of the other mobile terminal apparatus from the name information stored in the phone-number-information storing unit; and
a display control unit that controls a display unit to display thereon acquired name.

2. The mobile terminal apparatus according to claim 1, wherein the phone-number-information storing unit further stores therein an expiration date of the name information and the phone-number information,
the mobile terminal apparatus further comprising an expiration-date confirming unit that confirms validity of the expiration date stored in the phone-number-information storing unit,
when it is confirmed that the expiration date of the acquired receiver phone number is valid, the outgoing-call-request transmitting unit transmits the outgoing-call request to the acquired receiver phone number, and
when it is confirmed that the expiration date of the acquired receiver phone number has passed, the display control unit controls the display unit to display thereon a hiding-number call.

3. The mobile terminal apparatus according to claim 2, further comprising an information-manipulation receiving unit that receives a new registration, an edit, and a delete of the name information, the phone-number information, and the expiration date and stores received information in the phone-number-information storing unit.

4. The mobile terminal apparatus according to claim 3, wherein the information-manipulation receiving unit receives the new registration, the edit, and the delete of the name information, the phone-number information, and the expiration date via a network distribution.

5. The mobile terminal apparatus according to claim 3, wherein the information-manipulation receiving unit receives the new registration, the edit, and the delete of the name information, the phone-number information, and the expiration date via an external medium.

6. The mobile terminal apparatus according to claim 2, further comprising an information deleting unit that confirms whether the expiration data has passed for the name information and the phone-number information at regular intervals, and when it is confirmed that the expiration data has passed, deletes the name information and the phone-number information for which the expiration data has passed from the phone-number-information storing unit.

7. A method of controlling transmission and reception of request between a mobile terminal apparatus and other mobile terminal apparatus via a network, the method comprising:
storing name information of a user of the other mobile terminal apparatus in association with phone-number information unique to the other mobile terminal apparatus in a phone-number-information storing unit;
acquiring, when a name of the user of the other mobile terminal apparatus is received from a user of the mobile terminal apparatus, a receiver phone number corresponding to received name from the phone-number information stored in the phone-number-information storing unit;
transmitting an outgoing-call request including a caller phone number of the mobile terminal apparatus and a phone-number hiding flag for hiding the caller phone number to acquired receiver phone number via the network;
receiving an outgoing-call request transmitted from the other mobile terminal apparatus via the network as an incoming-call request;
confirming whether a phone-number hiding flag is included in received incoming-call request;
acquiring, when it is confirmed that the phone-number hiding flag is included in the received incoming-call request, a name corresponding to a caller phone number of the other mobile terminal apparatus from the name information stored in the phone-number-information storing unit; and
controlling a display unit to display thereon acquired name.

8. The method according to claim 7, wherein the storing includes storing an expiration date of the name information and the phone-number information in the phone-number-information storing,
the method further comprising confirming validity of the expiration date stored in the phone-number-information storing unit,
when it is confirmed that the expiration date of the acquired receiver phone number is valid, the transmitting includes transmitting the outgoing-call request to the acquired receiver phone number, and
when it is confirmed that the expiration date of the acquired receiver phone number has passed, the controlling includes controlling the display unit to display thereon a hiding-number call.

9. The method according to claim 8, further comprising receiving a new registration, an edit, and a delete of the name information, the phone-number information, and the expiration date and the storing includes storing received information in the phone-number-information storing unit.

10. The method according to claim 9, wherein the receiving includes receiving the new registration, the edit, and the delete of the name information, the phone-number information, and the expiration date via a network distribution.

11. The method according to claim 9, wherein the receiving includes receiving the new registration, the edit, and the delete of the name information, the phone-number information, and the expiration date via an external medium.

12. The method according to claim 8, further comprising confirming whether the expiration data has passed for the name information and the phone-number information at regular intervals, and when it is confirmed that the expiration data has passed, deleting the name information and the phone-number information for which the expiration data has passed from the phone-number-information storing unit.

13. A computer-readable recording medium that stores therein a computer program that implements on a computer a method of controlling transmission and reception of request between a mobile terminal apparatus and other mobile terminal apparatus via a network, wherein the computer program causes the computer to execute:
storing name information of a user of the other mobile terminal apparatus in association with phone-number information unique to the other mobile terminal apparatus in a phone-number-information storing unit;
acquiring, when a name of the user of the other mobile terminal apparatus is received from a user of the mobile terminal apparatus, a receiver phone number corresponding to received name from the phone-number information stored in the phone-number-information storing unit;
transmitting an outgoing-call request including a caller phone number of the mobile terminal apparatus and a phone-number hiding flag for hiding the caller phone number to acquired receiver phone number via the network;
receiving an outgoing-call request transmitted from the other mobile terminal apparatus via the network as an incoming-call request;
confirming whether a phone-number hiding flag is included in received incoming-call request;
acquiring, when it is confirmed that the phone-number hiding flag is included in the received incoming-call request, a name corresponding to a caller phone number of the other mobile terminal apparatus from the name information stored in the phone-number-information storing unit; and
controlling a display unit to display thereon acquired name.

14. The computer-readable recording medium according to claim 13, wherein the storing includes storing an expiration date of the name information and the phone-number information in the phone-number-information storing,
the computer program further causes the computer to execute confirming validity of the expiration date stored in the phone-number-information storing unit,
when it is confirmed that the expiration date of the acquired receiver phone number is valid, the transmitting includes transmitting the outgoing-call request to the acquired receiver phone number, and
when it is confirmed that the expiration date of the acquired receiver phone number has passed, the controlling includes controlling the display unit to display thereon a hiding-number call.

15. The computer-readable recording medium according to claim 14, wherein
the computer program further causes the computer to execute receiving a new registration, an edit, and a delete of the name information, the phone-number information, and the expiration date and the storing includes storing received information in the phone-number-information storing unit.

16. The computer-readable recording medium according to claim 15, wherein the receiving includes receiving the new registration, the edit, and the delete of the name information, the phone-number information, and the expiration date via a network distribution.

17. The computer-readable recording medium according to claim 15, wherein the receiving includes receiving the new registration, the edit, and the delete of the name information, the phone-number information, and the expiration date via an external medium.

18. The computer-readable recording medium according to claim 14, wherein the computer program further causes the computer to execute:
confirming whether the expiration data has passed for the name information and the phone-number information at regular intervals, and when it is confirmed that the expiration data has passed, deleting the name information and the phone-number information for which the expiration data has passed from the phone-number-information storing unit.

19. An apparatus for controlling transmission of an outgoing-call request from a transmission-source mobile terminal apparatus and reception of the outgoing-call request by a reception-destination mobile terminal apparatus from among a plurality of mobile terminal apparatuses, the apparatus comprising:
a phone-number-information storing unit that stores therein name information of users of the mobile terminal apparatuses in association with phone-number information of the mobile terminal apparatuses;
a name-information acquiring unit that acquires, when an outgoing-call request including a caller phone number and a phone-number hiding flag for hiding the caller phone number to the reception-destination mobile terminal apparatus is received from the transmission-source mobile terminal apparatus, a name corresponding to the caller phone number from the name information stored in the phone-number-information storing unit; and
a display control unit that controls, when transferring the outgoing-call request to the reception-destination mobile terminal apparatus, a display unit of the reception-destination mobile terminal apparatus to display thereon acquired name.

20. The apparatus according to claim 19, wherein the phone-number-information storing unit stores therein an expiration date of the name information and the phone-number information,
the apparatus further comprising an expiration-date confirming unit that confirms at regular intervals validity of the expiration date stored in the phone-number-information storing unit,
when it is confirmed that the expiration date of the acquired receiver phone number is valid, the apparatus transfers the outgoing-call request to the reception-destination mobile terminal apparatus, and
when it is confirmed that the expiration date of the acquired receiver phone number has passed, the display control unit controls the display unit to display thereon a hiding-number call.
